(19) United States
(12) Patent Application Publication
(10) Pub. No.: US 2014/0184171 A1
(43) Pub. Date: Jul. 3, 2014

(54) MOBILE TERMINAL IN WHICH WIRED CHARGING AND WIRELESS CHARGING ARE AVAILABLE AND METHOD OF CHARGING THEREOF

(71) Applicant: SAMSUNG ELECTRONICS CO., LTD., SUWON-SI (KR)

(72) Inventors: Janghoon LEE, Gumi-si (KR); Soonsang PARK, Daegu (KR)

(73) Assignee: SAMSUNG ELECTRONICS CO., LTD., SUWON-SI (KR)

(21) Appl. No.: 14/142,116

(22) Filed: Dec. 27, 2013

(30) Foreign Application Priority Data
Dec. 28, 2012 (KR) 10-2012-0155970

(51) Int. Cl. H02J 7/00

(52) U.S. Cl. CPC H02J 7/0055
USPC 320/138

(57) ABSTRACT

A mobile terminal with wired charging and wireless charging is provided. The mobile terminal includes a wireless charging interface unit that receives a current provided from a wireless charging apparatus, a wired charging interface unit connected to an external charging device by wire to receive outside power, a detection unit that detects whether power is supplied from outside of the mobile terminal through the wireless charging interface unit and the wired charging interface unit and that outputs charging input information to a controller, a switching unit that outputs power supplied through at least one of the wireless charging interface unit and the wired charging interface unit to a charging unit, the charging unit connected to the switching unit to charge a battery with power received through the switching unit, and a controller that divides a charging mode based on charging input information output from the detection unit.

### CROSS-REFERENCE TO RELATED APPLICATION(S)

This application claims the benefit under 35 U.S.C. §119(a) of a Korean patent application filed on Dec. 28, 2012 in the Korean Intellectual Property Office and assigned Serial No. 10-2012-0155970, the entire disclosure of which is hereby incorporated by reference.

### TECHNICAL FIELD

The present disclosure relates to a charging apparatus in which wired charging and wireless charging are available and a method of charging thereof. More particularly, the present disclosure relates to a mobile terminal in which wired charging and wireless charging are available and a method of charging thereof.

### BACKGROUND

In general, a mobile terminal, smart phone, tablet Personal Computer (PC), and portable electronic device are driven using power of a rechargeable battery. Such a battery has a limited use time, and therefore once the battery is drained, a user needs to recharge the battery before using the battery. In order for the user to charge or recharge the battery, the user supplies electrical energy to the battery using a separate charging apparatus. In general, in order to recharge a battery, a mobile terminal manufacturer may provide a wired charging apparatus (e.g., a wired cable or a wired USB) that can charge the battery.

Nowadays, while interest has increased in wireless charging technology, non-contact point charging technology, or proximity wireless charging technology to solve inconvenience of a wired charging apparatus, mobile terminals in which wired and wireless charging are available have been developed. However, when a wired charging method is detected while performing wireless charging, a conventional mobile terminal in which wired and wireless charging are available is preferentially converted to a wired charging method and performs charging using the wired charging method. However, as wireless charging technology is continuously developed, amperage of a wireless charging method increases. In such a wireless charging method, as a distance between a wireless charger and a mobile terminal decreases, a charging current increases.

A continuously developing wireless charging method has a charging current greater than a wired charging method, but a battery may still continue to charge using the wired charging method if it is currently being charged using the wired charging method. Thereby, a method that can shorten a charging time exists. However, when a wired charging method is detected while performing wireless charging, regardless of charging amperage of wired charging and wireless charging, a conventional mobile terminal is converted from wireless charging to wired charging and charges a battery using the wired charging method. Thereby, although a conventional mobile terminal can shorten a charging time by charging the battery with the wireless charging method, a problem exists that the conventional mobile terminal is charged only with the wired charging method. Therefore, in a method of charging a mobile terminal, a method of converting the charging method to a more efficient charging method in wired charging and wireless charging based on wireless charging technology is requested.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a mobile terminal in which wired charging and wireless charging are available and a method of charging thereof. The present disclosure also provides a mobile terminal that can convert to an efficient charging method in a present situation by checking amperages of a present charging method and a detected charging method, when a charging request of another charging method is detected while performing wired charging or wireless charging.

In accordance with an aspect of the present disclosure, a method of controlling charging of a mobile terminal in which wired charging and wireless charging are available is provided. The method includes receiving first charging input information from one of a wired charging interface unit and a wireless charging interface unit, controlling a switching unit to charge a battery through a first charging interface unit corresponding to the first charging input information, measuring amperages of the first charging interface unit and a second charging interface unit, when receiving second charging input information by the second charging interface unit while charging the battery through the first charging interface unit, and changing, if amperage of the second charging interface unit is greater than that of the first charging interface unit, a charging method by controlling the switching unit to be charged with power provided by the second charging interface unit.

In accordance with another aspect of the present disclosure, a mobile terminal in which wired charging and wireless charging are available is provided. The mobile terminal includes a wireless charging interface unit that receives a current provided from a wireless charging apparatus, a wired charging interface unit connected to an external charging device by wire to receive outside power, a detection unit that detects whether power is supplied from the outside through the wireless charging interface unit and the wired charging interface unit and that outputs charging input information to a controller, a switching unit that outputs power supplied through at least one of the wireless charging interface unit and the wired charging interface unit to a charging unit, the charging unit connected to the switching unit to charge a battery with power received through the switching unit, and a controller that divides a charging mode based on charging input information output from the detection unit and that measures amperages of wireless charging and wired charging inputs, when a charging event by another input is detected while charging a battery with one input of one of the wired charging interface unit and the wireless charging interface unit and that controls the switching unit to charge the battery based on a charging input of relatively greater amperage in the wired charging interface unit and the wireless charging interface unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a mobile terminal in which wired charging and wireless charging is available according to an embodiment of the present disclosure;

FIG. 2 is a flowchart illustrating a method of charging the mobile terminal of FIG. 1 according to an embodiment of the present disclosure;

FIG. 3 illustrates an interface screen of wired and wireless charging states of the mobile terminal of FIG. 1 according to an embodiment of the present disclosure;

FIG. 4 is a flowchart illustrating a method of charging a mobile terminal in which wired charging and wireless charging is available according to another embodiment of the present disclosure; and

FIG. 5 illustrates an interface screen of wired and wireless charging states of the mobile terminal of FIG. 4 according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before a detailed description, a wireless charging method may be divided into an electromagnetic induction type and a magnetic resonance type. In the electromagnetic induction type, by applying an AC current to a transmitting coil (e.g., a coil of a charging pad) to transmit wireless power, when a magnetic field is changed, a battery may be charged through an induced current generated in an adjacent receiving coil (e.g., an internal coil of a mobile terminal) due to a change of the magnetic field. In the magnetic resonance method, when a transmitting coil (e.g., a charging pad) radiates a magnetic field with a specific frequency and when a resonant coil (e.g., an internal coil of a mobile terminal) having the same frequency as that of a transmitting coil approaches, power may be received through an energy tunnel generated due to resonance and charge a battery. In the present disclosure, it is assumed that a wireless charging method is magnetic resonance type charging, but the present disclosure is not limited thereto.

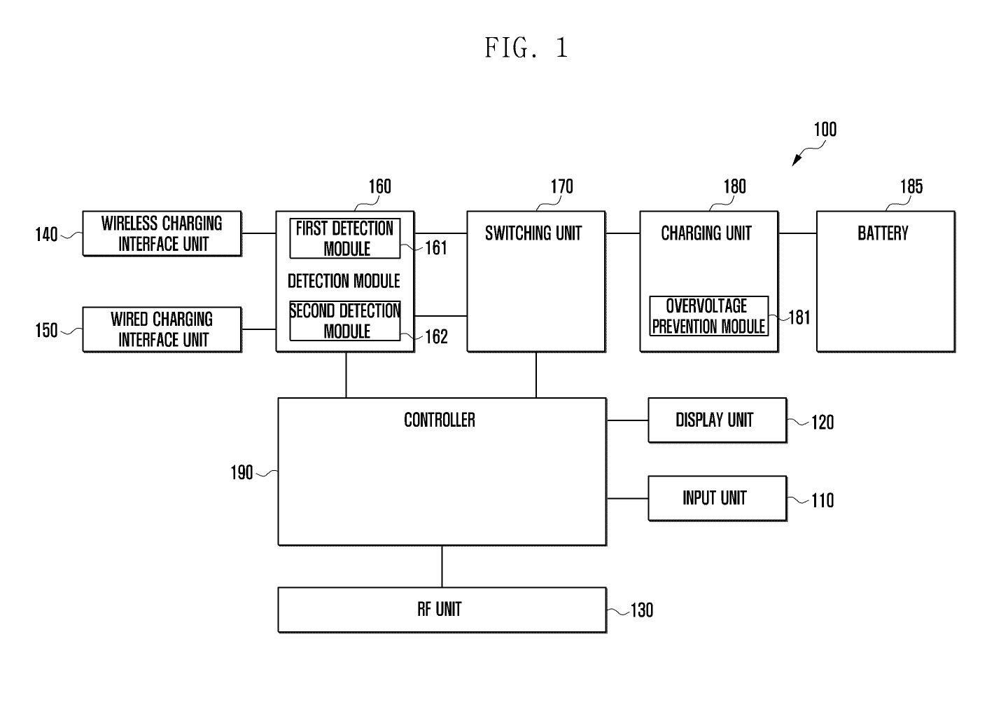

FIG. 1 is a block diagram illustrating a configuration of a mobile terminal in which wired charging and wireless charging are available according to an embodiment of the present disclosure.

Referring to FIG. 1, a mobile terminal 100 according to the present embodiment may include an input unit 110, display unit 120, Radio Frequency (RF) unit 130, wireless charging interface unit 140, wired charging interface unit 150, detection unit 160, switching unit 170, charging unit 180, battery 185, and controller 190.

The input unit 110 may receive an input signal and input various character information in relation to setting of mobile terminal functions and a function control and output the signal and the character information to the controller 190. The input unit 110 may be formed with one or a combination of input elements such as a touch pad, keypad of general key arrangement, QWERTY type keypad, and a function key set to perform a specific function according to an input provided on the mobile terminal.

The display unit 120 may display various menus of the mobile terminal 100, information in which a user inputs, or information provided to a user. The display unit 120 may display various screens, i.e., a User Interface (UI) or a Graphic User Interface (GUI) according to a use of the mobile terminal 100. The display unit 120 may provide a menu screen, message writing screen, communication screen, game screen, music reproduction screen, and moving picture reproduction screen. Such a display unit 120 may be formed in a form of a flat display panel such as a Liquid Crystal Display (LCD), Organic Light Emitting Diode (OLED), and Active Matrix Organic Light Emitting Diode (AMOLED), but the display unit is not limited thereto.

In the present embodiment, when a touch panel that detects a touch action is formed in a touch screen form formed in an interlayer structure, the display unit 120 may be used as an input element in addition to an output element. That is, in the mobile terminal 100, when the display unit 120 is formed in a touch screen form, the display unit 120 may include a touch panel that detects a touch action. The touch panel may be formed to convert a pressure applied to a specific portion of the display unit 120 or a change of capacitance generating in a specific portion of the display unit 120 to an electrical input signal. The touch panel may be embodied in an add-on type positioned on the display unit 120 or an on-cell type or in-cell type inserted within the display unit 120. In the touch panel, a resistive type, capacitive type, electromagnetic induction type, and pressure type may be applied. The touch panel may be formed to detect a pressure upon touching as well as a touched position and area. For example, when a touch is input to the touch panel, an analog signal (e.g., a touch event) corresponding to the touch input occurs, the touch panel performs A/D conversion of the analog signal and outputs a digital signal to the controller 190. Here, the touch event may include a touch coordinate. When a touch coordinate is received from the touch panel, the controller 190 determines that a touch device (e.g., a finger or a pen) is touched in the touch panel, and when a touch coordinate is not received from the touch panel, the controller 190 determines that a touch is released. Accordingly, the controller 190 may determine a user's touch input information from an input signal and perform functions corresponding thereto.

The RF unit 130 may perform communication of the mobile terminal 100. As a supportable mobile communication network forms a predetermined communication channel, the RF unit 130 may perform communication such as audio dedicated communication, audiovisual communication, and data communication. The RF unit 130 may include an RF transmitter for up-converting a frequency of a signal to be transmitted and amplifying the signal, and an RF receiver for down-converting a frequency of a received signal and low-noise amplifying the signal. Further, the RF unit 130 may include a mobile communication module (e.g., 3-generation mobile communication module, 3.5-generation mobile communication module, or 4-generation mobile communication module), and digital broadcasting module (e.g., DMB module).

The wireless charging interface unit 140 may receive wireless power from a wireless power supply apparatus (e.g., wireless charging pad) and output the received power to the charging unit 180. The wireless charging interface unit 140 may include a power receiver (e.g., coil portion) for power wireless reception and magnetic field communication. The power receiver may be formed with a coil portion and a capacitor that generates an induced current due to a change of a magnetic field, or that receives power through an energy tunnel generated due to resonance based on a specific frequency.

The wired charging interface unit 150 may connect an external power supply apparatus and a charging unit. In the wired charging interface unit 150, a power supply apparatus, for example a Travel Adapter (TA) or a Travel Charger (TC) that converts AC power to DC power, or a micro USB cable may be connected. The wired charging interface unit 150 may have the same interface specification (e.g., 20 pin interface and a micro USB interface) as that of a generally used wired charger. When an external power supply apparatus is connected, the wired charging interface unit 150 may receive the supply of power through a connected wire to output the power to the charging unit 180. Here, when the wired charging interface unit 150 is connected through a USB cable, the wired charging interface unit 150 may perform data communication with a PC, and receive the supply of power from a PC to output the power to the charging unit 180.

When power is supplied from the wireless charging interface unit 140 or the wired charging interface unit 150, the detection unit 160 may output charging data of supplied power to the controller 190. The detection unit 160 may measure a current and a voltage of power supplied through the wireless charging interface unit 140 or the wired charging interface unit 150. Charging data may include power, for example, a measured value of a current and a voltage supplied from the wireless charging interface unit 140 and the wired charging interface unit 150.

The detection unit 160 may include a first detection module 161 that detects power supplied through the wireless charging interface unit 140 and a second detection module 162 that detects power supplied through the wired charging interface unit 150, but the detection unit 160 is not limited thereto. The controller 190 may determine whether power is supplied through the wireless charging interface unit 140 or through the wired charging interface unit 150 through charging data received from the detection unit 160. Specifically, when charging data is received from the first detection module 161, the controller 190 may recognize that a charging operation is performed through the wireless charging interface unit 140. When charging data is received from the second detection module 162, the controller 190 may recognize that a charging operation is performed through the wired charging interface unit 150.

The switching unit 170 may be connected to the detection unit 160 and the charging unit 180 and perform a function of outputting power between the detection unit 160 and the charging unit 180. The switching unit 170 may be switched by the control of the controller 190 to output power received through the first detection module 161 to the charging unit 180 or to output power received through the second detection module 162 to the charging unit 180.

The charging unit 180 may perform charging with a method of constant current charging or constant voltage charging. The charging unit 180 may charge the battery 185 using power supplied from the wireless charging interface unit 140 or the wired charging interface unit 150 by the control of the controller 190. For example, when power is detected through the wired charging interface unit 150 or the wireless charging interface unit 140, the controller 190 may detect the power and control a charging operation by driving the charging unit 180. The controller 190 may detect a residual quantity of the battery 185 and control the charging unit 180 to terminate a charging operation when the battery 185 is in a 100% charging state. For example, when charging of the battery 185 is necessary, the controller 190 may control to supply a constant current or may control to supply a constant voltage when battery charging is complete.

The charging unit 180 may include an overvoltage prevention module 181 to adjust a charging current and to prevent a voltage (hereinafter, an overvoltage) of a reference value or more from being provided into a battery. Further, although not shown in the drawings, the charging unit 180 may include a step-down circuit to drop a charging voltage to a battery voltage.

The battery 185 may be various rechargeable batteries such as a lithium ion battery, lithium ion polymer battery, nickel cadmium battery, and nickel hydrogen battery, but is not limited thereto. The battery 185 may convert and accumulate electrical energy that is input from the charging unit 180 to chemical energy, convert the accumulated chemical energy to electrical energy, and supply the electrical energy to modules for operating the mobile terminal 100.

The controller 190 may perform a function of controlling general operations of the mobile terminal 100 and a message flow between constituent elements of the mobile terminal 100, and a function of processing data. The controller 190 may control power supply from the battery 185 to the constituent elements. When power is supplied, in order to control a booting process of the mobile terminal 100 and to execute a function of the mobile terminal 100 according to the user's setting, the controller 190 may execute various application programs stored at a program area.

The controller 190 may control function operation related to wireless charging and wired charging of the present embodiment. The controller 190 may divide a charging change mode and control an operation execution according to a divided mode.

Hereinafter, a detailed function of the controller 190 is described in detail with reference to a flowchart.

Although not shown in the drawings of the present disclosure, a mobile terminal according to another embodiment of the present disclosure may further include a storage unit. The storage unit may store an Operating System (OS) and various applications (hereinafter, App) of the mobile terminal 100, and various data generated in the mobile terminal 100. The data may include data occurring when executing an App of the mobile terminal 100 and storable data forms generated using the mobile terminal 100 or received from the outside (e.g., external server, another mobile terminal, and PC).

The storage unit may store a user interface provided in the mobile terminal and various setting information to process a function of the mobile terminal. The storage unit may include at least one type storage medium of a memory such as a flash memory type, hard disk type, micro type, and card type (e.g., a Secure Digital (SD) card or an extreme digital (XD) card) and a memory such as a random access memory (RAM), static RAM (SRAM), Read-Only Memory (ROM), Programmable ROM (PROM), Electrically Erasable PROM (EEPROM), Magnetic RAM (MRAM), magnetic disk, an optical disk type and the like.

According to the trend of digital convergence, the mobile terminal 100 according to the present disclosure may further include a sensor module to detect information related to a position change thereof, GPS module to measure a position of the mobile terminal 100, and camera module. Further, in the mobile terminal 100 of the present disclosure, a specific element may be excluded from the configuration or may be replaced with another element according to a providing form thereof. Further, in the present disclosure, the input unit may be a touch screen, key input unit, a touchpad, and a track ball.

An apparatus in which wired charging and wireless charging is available and a method of charging thereof according to the present disclosure may be applied to the mobile terminal. Such a mobile terminal may be a mobile phone, smart phone, tablet PC, hand-held PC, Portable Multimedia Player (PMP), and Personal Digital Assistant (PDA). Hereinafter, it is assumed that an apparatus and method according the present disclosure is applied to the mobile terminal.

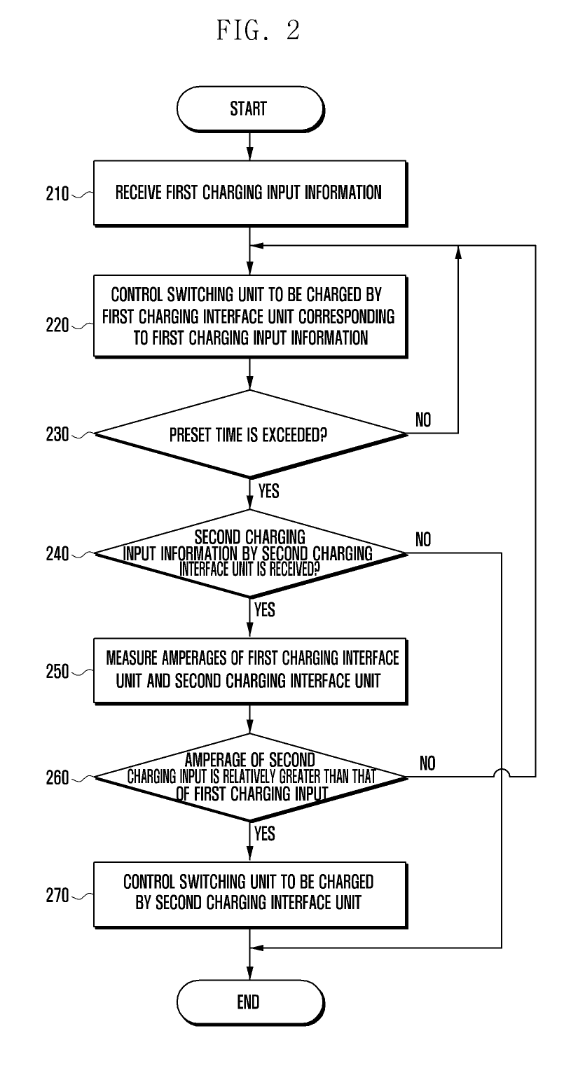

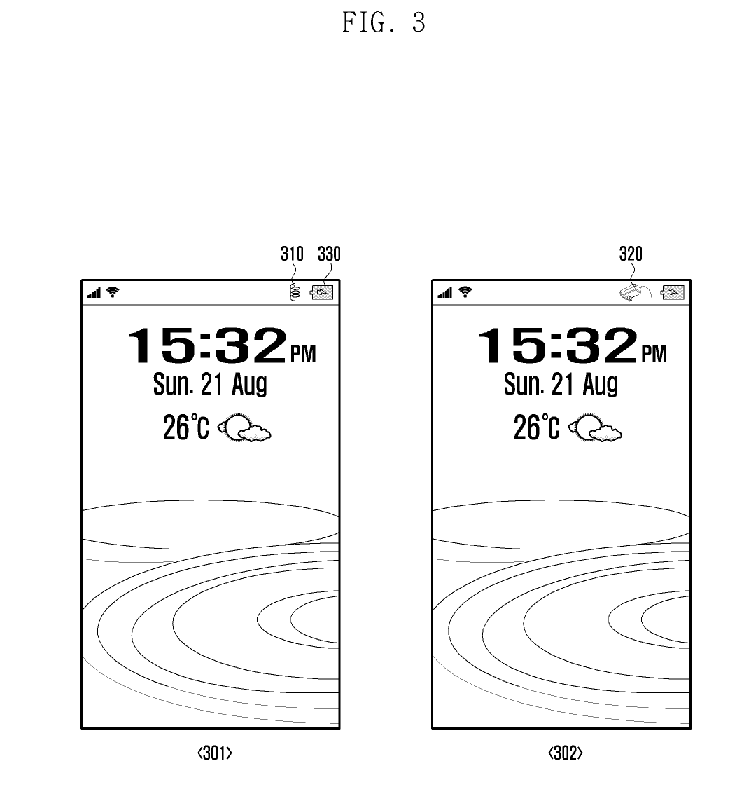

FIG. 2 is a flowchart illustrating a method of charging the mobile terminal of FIG. 1. FIG. 3 illustrates a screen interface that displays charging mode information of the mobile terminal of FIG. 1. Here, FIGS. 2 and 3 illustrate an automatic charging change method in a mobile terminal according to an embodiment of the present disclosure.

Referring to FIG. 2, the controller 190 may receive first charging input information from the detection unit 160 at operation 210. The first charging input information may include detection information and a measured value of charging power. For example, when the wired charging interface unit 150 and an external power supply device are connected, power of the external power supply device may be provided through a connected wired cable. The detection unit 160 may detect a connection to the external power supply device, measure a current and a voltage of the provided power, and output charging data to the controller 190.

The controller 190 may control the switching unit 170 to charge the battery 185 with power supplied through the first charging interface unit based on the first charging input information at operation 220. Specifically, when the controller 190 receives the first charging input information from the first detection module 161, the controller 190 may recognize as a wireless charging input signal, the controller 190 may control the switching unit 170 to output power received from the wireless charging interface unit 140 to the charging unit 180. Further, when the controller 190 receives the first charging input information from the second detection module 162, the controller 190 may recognize the first charging input information as a wired charging input signal, the controller 190 may control the switching unit 170 to output power provided into the wired charging interface unit 150 to the charging unit 180.

Thereafter, power generated at the outside or provided from the outside through the wired charging interface unit 150 or the wireless charging interface unit 140 may pass through the switching unit 170 via the first detection module 161 or the second detection module 162 and be output to the charging unit 180. The charging unit 180 may generate a constant voltage and a constant current to charge the battery using received power and supply the generated constant voltage and constant current to the battery 185.

Here, the controller 190 may recognize a charging state in a charging mode (e.g., a wireless charging mode or a wired charging mode) according to first charging input information continuously received from the detection unit 160. The controller 190 may display charging mode information according to the first charging input information in the display unit 120. In the charging input information, as shown in FIG. 3, an icon indicating a charging mode may be displayed in the display unit 120, however the present disclosure is not limited thereto. For example, as shown in a screen <301> of FIG. 3, when first charging input information is received from the wireless charging interface unit 140, the controller 190 may control to display an icon 310 indicating a wireless charging mode. Further, as shown in a screen <302> of FIG. 3, when first charging input information is received from the wired charging interface unit 150, the controller 190 may control the display unit 120 to display an icon 320 indicating a wired charging mode. This is an illustration and the present disclosure is not limited thereto. Further, the controller 190 may control to display an icon 330 representing a charging state in the display unit 120 while displaying wireless charging mode information.

After first charging input information is received, the controller 190 may determine whether a preset time is exceeded at operation 230. Here, the preset time may be a time set to be charged in a present charging mode for a minimum time. That is, the preset time may be a time set to prevent a charging method from being frequently converted and may be set by a user or may be set when producing a mobile terminal. Specifically, when the first charging input information is received from the detection unit 160, the controller 190 may operate a timer. That is, the controller 190 may count a timer from a time point at which the first charging input information is received. After the timer operates, the controller 190 may determine whether a preset time is exceeded.

If a preset time is exceeded, the controller 190 may determine whether second charging input information by the second charging interface unit is received at operation 240. That is, the controller 190 may simultaneously receive the first charging input information and the second charging input information. While receiving the first charging input information, when the second charging input information is received, the controller 190 may recognize that a charging request of a method different from a present charging method is detected. For example, the controller 190 may receive wired charging input information from the second detection module 162 while receiving wireless charging input information from the first detection module 161 or the controller 190 may receive wireless charging input information from the first detection module 161 while receiving wired charging input information from the second detection module 162.

If a preset time has not elapsed, the process returns to operation 220.

If second charging input information is received, the controller 190 may measure amperages based on measured values included in the first charging input information and the second charging input information at operation 250. That is, the controller 190 may calculate amperage of a first charging input provided through the first charging interface unit and calculate amperage of a second charging input provided through the second charging interface unit.

The controller 190 may determine whether amperage of a second charging input is relatively greater than that of a first charging input at operation 260.

If amperage of a second charging input is relatively greater than that of a first charging input, the controller 190 may control the switching unit 170 to charge a charging current, i.e., a battery through a second charging interface unit corresponding to second charging input information at operation 270. That is, if amperage of a second charging input is relatively greater than that of a first charging input, the controller 190 may control the switching unit 170 to intercept power supply of the first charging interface unit and to supply power supplied from the second charging interface unit to the charging unit 180.

Thereafter, the controller 190 may determine whether charging is complete, and if charging is complete, the controller 190 may control to display charging completion information in the display unit 120, and the process may be terminated.

In this way, when charging power is detected through the second charging interface unit while charging a battery through the first charging interface unit, a mobile terminal in which wired charging and wireless charging is available according to the present disclosure may control to charge with relatively greater charging amperage by comparing each charging amperage.

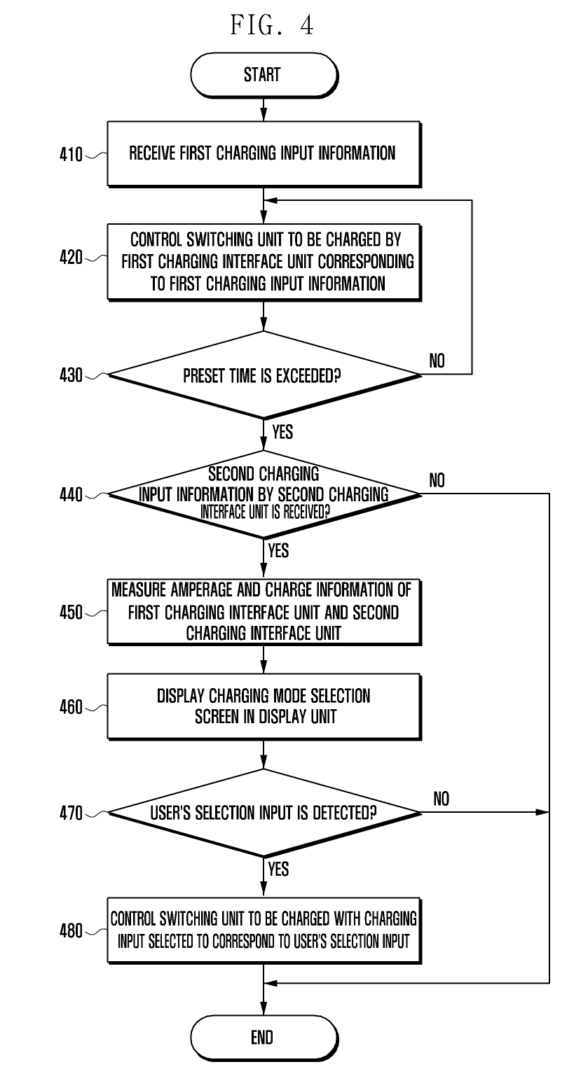

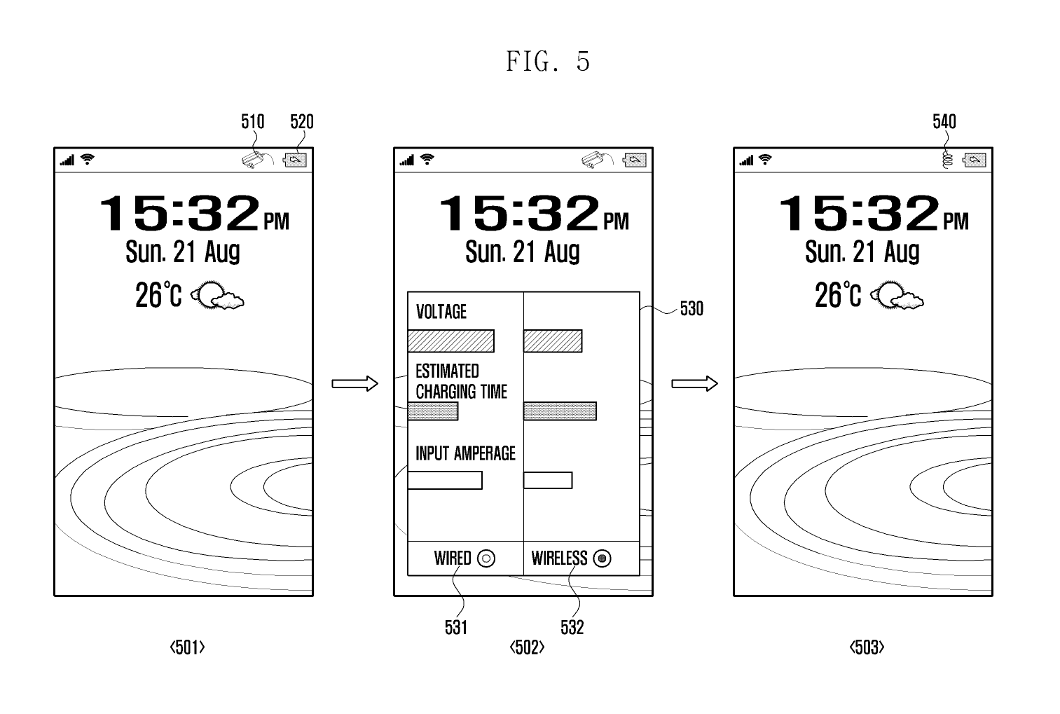

FIG. 4 is a flowchart illustrating a method of charging a mobile terminal in which wired charging and wireless charging are available according to another embodiment of the present disclosure. FIG. 5 illustrates a screen interface that controls a charging method of the mobile terminal of FIG. 4. Here, FIGS. 4 and 5 illustrate a manual charging change method in a mobile terminal according to an embodiment of the present disclosure.

Referring to FIG. 4, the controller 190 may receive first charging input information from the detection unit 160 at operation 410. The first charging input information may include detection information and a measured value of charging power. For example, when the wired charging interface unit 150 and an external power supply device are connected, power of the external power supply device may be provided through the connected wire cable. The detection unit 160 may detect a connection to the external power supply device, measure a current and a voltage of provided power, and output charging data to the controller 190.

The controller 190 may control the switching unit 170 to charge the battery 185 with power supplied through the first charging interface unit based on the first charging input information at operation 420. Specifically, when the controller 190 receives the first charging input information from the first detection module 161, the controller 190 may recognize the first charging input information as a wireless charging input signal and control the switching unit 170 to output power received from the wireless charging interface unit 140 to the charging unit 180. Further, when the controller 190 receives the first charging input information from the second detection module 162, the controller 190 may recognize the first charging input information as a wired charging input signal and control the switching unit 170 to output power provided into the wired charging interface unit 150 to the charging unit 180.

Thereafter, power generated at the outside or provided from the outside through the wired charging interface unit 150 or the wireless charging interface unit 140 may pass through the switching unit 170 via the first detection module 161 or the second detection module 162 and be output to the charging unit 180. The charging unit 180 may generate a constant voltage and a constant current to charge the battery using received power and supply the generated constant voltage and constant current to the battery 185.

Here, the controller 190 may recognize a charging state in a charging mode (e.g., a wireless charging mode or a wired charging mode) according to first charging input information received from the detection unit 160. The controller 190 may display charging mode information according to the first charging input information in the display unit 120. For example, when the controller 190 recognizes that charging is performed in a wired charging mode through first charging input information, the controller 190 may control to display an icon 510 indicating a wired charging mode in the display unit 120, as shown in <501> of FIG. 5. Simultaneously, the controller 190 may control to display an icon 520 representing a charging state in the display unit 120.

When the first charging input information is received, the controller 190 may determine whether a preset time is exceeded at operation 430. Here, the preset time may be a time set to be charged in a present charging mode for a minimum time. That is, the preset time may be a time set to prevent a charging method from being frequently converted and may be set by a user or may be set when producing a mobile terminal. Specifically, when the first charging input information is received from the detection unit 160, the controller 190 may operate a timer. That is, the controller 190 may count a timer from a time point at which the first charging input information is received. After the timer operates, the controller 190 may determine whether a preset time is exceeded.

If a preset time is exceeded, the controller 190 may determine whether second charging input information by the second charging interface unit is received at operation 440. That is, the controller 190 may simultaneously receive the first charging input information and the second charging input information. While receiving the first charging input information, when the second charging input information is received, the controller 190 may recognize that a charging request of a method different from a present charging method is detected. For example, the controller 190 may receive wired charging input information from the second detection module 162 while receiving wireless charging input information from the first detection module 161 or the controller 190 may receive wireless charging input information from the first detection module 161 while receiving wired charging input information from the second detection module 162.

If a preset time has not elapsed, the process returns to operation 420.

If the second charging input information is received, the controller 190 may measure each amperage and charge information based on measured values included in the first charging input information and the second charging input information at operation 450.

The controller 190 may control to display first charging state information by the first charging interface and second charging state information by the second charging interface unit in the display unit 120 at operation 460. For example, when the second charging input information is received, in order to provide charging information to the user, the controller 190 may control to display a charging mode selection screen 530 in the display unit 120, as shown in a screen <502> of FIG. 5. Charging selection information may include charging state information 531 of power provided through the wired charging interface unit and charging state information 532 of power provided through the wireless charging interface unit. Such charging selection information may be provided with a pop-up window displayed to be overlapped on an execution screen (e.g., a home screen or a messenger execution screen) displayed in the display unit 120, but the present disclosure is not limited thereto. Further, charging selection information may include input amperage, an estimated charging time, and a voltage value. The user can determine information about wired charging or wireless charging through charging selection information and may select a particular charging method.

The controller 190 may determine whether the user's selection input is detected at operation 470, and the controller 190 may control the switching unit 170 to be charged with a charging input selected to correspond to the user's selection input at operation 480. For example, the user may select to charge with a wireless charging method on the screen <502> of FIG. 5. The controller 190 may control the switching unit 170 to change a charging mode in response to a user's selection for wireless charging. Therefore, the switching unit 170 may intercept power supplied through the wired charging interface unit 150 and connect the first detection module 161 of the detection unit 160 and the charging unit 180 to charge the battery 185 with power supplied through the wireless charging interface unit 140. When the first detection module 161 and the charging unit 180 are connected, power provided through the wireless charging interface unit 140 may be supplied to the battery 185 through the charging unit 180. When the mobile terminal 100 is in a charging state with a wireless charging method in response to the user's selection input, the controller 190 may control to display an icon 540 indicating a wireless charging mode in the display unit 120, as shown in <503> of FIG. 5.

As described above, in a mobile terminal in which wired charging and wireless charging are available and a method of charging thereof according to an embodiment of the present disclosure, wired charging and wireless charging can be performed. Further, when a charging request by another method is detected while charging a battery with one method, amperages of a present charging method and a detected charging method are calculated, and by comparing the calculated amperages, a charging method can be changed to a method having greater efficiency. In this way, in the present disclosure, while charging a battery with one method, when a charging request requesting to charge with another method is detected, and by recognizing a charging situation, a change method can be changed to a most efficient charging method. Thereby, a charging time can be reduced, and use efficiency of a charging apparatus and user convenience can be improved.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling charging of a mobile terminal in which wired charging and wireless charging is available, the method comprising:
receiving first charging input information from one of a wired charging interface unit and a wireless charging interface unit;
controlling a switching unit to charge a battery through a first charging interface unit corresponding to the first charging input information;
measuring amperages of the first charging interface unit and a second charging interface unit, when receiving second charging input information by the second charging interface unit while charging the battery through the first charging interface unit; and
changing, if amperage of the second charging interface unit is greater than that of the first charging interface unit, a charging method by controlling the switching unit to be charged with power provided by the second charging interface unit.

2. The method of claim 1, wherein the controlling of the switching unit comprises:
determining whether an input signal is a wireless charging input signal or a wired charging input signal based on the first charging input information; and
outputting a switching control signal to the switching unit to be charged with a charging method according to the determined input signal.

3. The method of claim 1, wherein the measuring of amperages of the first charging interface unit comprises:
determining whether a preset time is exceeded after receiving the first charging input information;
determining, if a preset time is exceeded, whether second charging input information is received from a detection unit; and
measuring, if the second charging input information is received, amperages of the first charging interface unit and the second charging interface unit.

4. The method of claim 1, wherein the first charging input information is charging input information detected from one of the wired charging interface unit and the wireless charging interface unit, and
the second charging input information is charging input information detected from one charging interface unit different from that of the first charging input information.

5. The method of claim 1, wherein the changing of the charging method comprises:
displaying a charging mode selection screen in a display unit based on measurement information of the first charging interface unit and the second charging interface unit;
detecting a user's selection input that selects the charging mode; and
controlling a switching unit to be charged with power provided through a charging interface unit selected to correspond to the user's selection input.

6. A mobile terminal in which wired charging and wireless charging are available, the mobile terminal comprising:
a wireless charging interface unit configured to receive a current provided from a wireless charging apparatus;
a wired charging interface unit connected to an external charging device by a wire to receive power from outside of the mobile terminal;
a detection unit configured to detect whether power is supplied from the outside of the mobile terminal through the wireless charging interface unit and the wired charging interface unit and that outputs charging input information to a controller;
a switching unit configured to output power supplied through at least one of the wireless charging interface unit and the wired charging interface unit to a charging unit;
the charging unit connected to the switching unit to charge a battery with power received through the switching unit; and
a controller configured to select a charging mode based on charging input information output from the detection unit and that measures amperages of wireless charging and wired charging inputs, when a charging event by another input is detected while charging the battery with one input of one of the wired charging interface unit and the wireless charging interface unit and that controls the switching unit to charge the battery based on a charging input of relatively greater amperage in the wired charging interface unit and the wireless charging interface unit.

7. The mobile terminal of claim 6, wherein the detection unit comprises:
a first detection module that detects power provided through the wireless charging interface unit and that measures a voltage value and a current value of the detected power; and
a second detection module that detects power provided through the wired charging interface unit and that measures a voltage value and a current value of the detected power.

8. The mobile terminal of claim 7, wherein the switching unit is connected to the first detection module and the second detection module and the switching unit connects one of the first detection module and the second detection module to the charging unit by control of the controller.

9. The mobile terminal of claim 6, wherein the controller operates a timer at a time point that charges the battery with one input of one of the wired charging interface unit and the wireless charging interface unit and determines whether a charging event by another input is detected, if a preset time is exceeded.

10. The mobile terminal of claim 6, wherein the controller controls to output a charging mode selection screen onto a display unit, when a charging event is detected by the another input and controls the switching unit to be charged with power provided through a charging interface unit selected to correspond to a user's selection input, when the user's selection input that selects a charging mode is detected.

11. The mobile terminal of claim 6, wherein the charging unit comprises an overvoltage prevention module configured to adjust a charging current and to prevent a voltage equal to or greater than a reference value from being provided to the battery.

12. A mobile terminal comprising:
a wireless charging interface unit configured to receive external power from a wireless charging apparatus;
a wired charging interface unit configured to receive external power from a wired charging apparatus;
a detection unit configured to detect whether the external power is supplied from the wireless charging apparatus or from the wired charging apparatus;
a switching unit configured to output power supplied from at least one of the wireless charging interface unit and the wired charging interface unit;
a charging unit connected to the switching unit and configured to charge a battery of the mobile terminal with the output power received from the switching unit; and
a controller configured to select a wireless charging mode or a wired charging mode based on charging input information output from the detecting unit.

13. The mobile terminal of claim 12, wherein the detection unit comprises:
a first detection module configured to detect the external power provided from the wireless charging apparatus and to measure a voltage value and a current value of the detected external power; and
a second detection module configured to detect the external power provided from the wired charging apparatus and to measure a voltage value and a current value of the detected external power.
